(19) United States
(12) Patent Application Publication
(10) Pub. No.: US 2008/0035696 A1
(43) Pub. Date: Feb. 14, 2008

(54) Sheet Product Package

(76) Inventors: Monica Stautner Nichols, Richmond, VA (US); Bruce Robbins, Richmond, VA (US); C. Douglas Powell, Richmond, VA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/835,881

(22) Filed: Aug. 8, 2007

Related U.S. Application Data
(60) Provisional application No. 60/821,794, filed on Aug. 8, 2006.

(51) Int. Cl. B65H 35/00; B26F 3/02; B65D 85/672

(52) U.S. Cl. 225/19; 225/41; 225/48; 225/50

(57) ABSTRACT

A sheet product package comprising a lid comprising four side surfaces and a top surface forming a first volume, the first and third side surfaces being parallel to each other, the second and fourth side surfaces being parallel with each other, and the first side surface, the third side surface, and the top surface collectively comprising an hourglass indent; a base comprising: four side surfaces and a bottom surface forming a second volume, the first and third side surfaces being substantially parallel to each other, the second and fourth side surfaces being substantially parallel to each other. The first side surface, the third side surface, and the bottom surface collectively comprise an hourglass indent; and, a cutting edge disposed along the first side of the base proximate to the second volume; and, a hinge, coupling the third surface of the lid and the third surface of the base.

This application claims priority from Provisional U.S. Patent Application Ser. No. 60/821,794, filed Aug. 8, 2006, which is hereby incorporated by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The instant disclosure relates to the field of packaging for sheet products, and more specifically provides a new package for sheet material, including, e.g., aluminum foil.

### BACKGROUND

Sheet products are used in a variety of industries. Perhaps the most well known sheet products are those used by consumers, including, without limitation, aluminum foil, plastic wrap, waxed paper, and parchment paper. These sheet products are typically sold to consumers or other end-users as elongate sheets which are rolled around a core, thereby allowing sheet products capable of covering a large area to be stored in a relatively small container.

Sheet products have been on the market for many years, and sheet product manufacturers spend a great deal of time and effort to create new forms of sheet products. Although manufacturers have focused on the composition and performance of the sheet products themselves, sheet product manufacturers have not significantly advanced sheet product packaging in many years. Sheet product packaging typically consists of a paperboard box into which a roll of sheet product is placed. In most cases, the user opens the box lid, pulls out a desired length of sheet product, and then closes the lid. Typically, either the lid or the base of the box includes serrated metal or plastic teeth that are then used to cut the sheet product to the desired length.

While such packaging is functional, it has proven to have disadvantages for consumers. For example, the end of the sheet product may fall back into the box after the cutting process, thereby necessitating that the user open the box and find the end before a new sheet product piece can be cut. For some sheet products, such as plastic wrap, this can be a difficult process. Some in the art have addressed this through the use of adhesive strips or other attachment means on the box which help hold the sheet product in place, but such strips can also attract foreign particles.

The packaging is frequently handled while a user is cooking or otherwise preparing or putting away foods, and the user's hands are typically wet or may have flour, grease, or other material on them. The rectangular shape of traditional sheet good packages makes it awkward and uncomfortable for the user to hold during the dispensing process due to the squared edges which do not conform well to the user's hand. This can result in stress on the user's hand and improperly dispensed, and thus wasted, sheet goods. Still further, because the packages are typically made of opaque paperboard, it is difficult for users to judge the amount of sheet goods remaining on the roll without removing the roll from the box.

### SUMMARY

The instant disclosure is directed to a sheet product package that substantially obviates one or more of the problems due to limitations and disadvantages of the related art. An embodiment is directed to a sheet product package comprising a box, wherein at least a portion of the box is clear or translucent, whereby the user can see the amount of sheet product remaining on the roll. An embodiment is directed to a sheet product package having an hourglass-like shape whereby the user can more easily and comfortably grip the container. An embodiment is directed to a sheet product package comprising a flange, whereby the end of the sheet product is made available to the user after the desired amount of sheet product has been dispensed and cut. An embodiment is directed to a sheet product package having a lid closure means, wherein the lid closure means secures the sheet product when the lid is closed, thereby making it easier to tear off the sheet product.

Additional features and advantages of the invention will be set forth in the description which follows, and in part will be apparent from the description, or may be learned by practice of disclosure. The objectives and other advantages will be realized and attained by the structure pointed out in the written description hereof as well as the appended drawings.

It is to be understood that both the foregoing general description and the following detailed description are exemplary and explanatory and are intended to provide further explanation of claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a front view of a sheet product package embodiment.

FIG. 2 is a top perspective view of a sheet product package embodiment.

FIG. 3 is a front perspective view of a sheet product package embodiment.

FIG. 4 is a rear perspective view of a sheet product package embodiment.

FIG. 5 is a bottom perspective view of a sheet product package embodiment.

FIG. 6 is a top perspective view of a sheet product package embodiment.

FIG. 7 is a right perspective view of a sheet product package embodiment.

FIG. 8 is a right perspective view of a sheet product package embodiment wherein the lid has been opened.

FIG. 9 is a front perspective view of a sheet product package embodiment illustrating an alternative lid and cutting edge arrangement.

FIG. 10 is a side view of a sheet product package embodiment.

FIG. 11 is an alternative side view of a sheet product package embodiment.

FIG. 12 is a front perspective view of a sheet product package embodiment.

FIG. 13 is a bottom perspective view of a sheet product package embodiment.

FIG. 14 is a front perspective view of a sheet product package embodiment with the lid in the open position.

FIG. 15 is a detailed top perspective view of an exemplary cutting edge as incorporated in a sheet product package embodiment.

FIG. 16 is a detailed front perspective view of an exemplary cutting edge ad incorporated in a sheet product package embodiment.

FIG. 17 is a detailed top perspective view of a sheet product package embodiment with the lid open, after sheet product has been dispensed.

FIG. 18 is a top view of a sheet product package embodiment with the lid open.

FIG. 19 is a right side view of a sheet product package embodiment.

FIG. 20 is a left view of a sheet product package embodiment.

FIG. 21 is a left perspective view of a sheet product package embodiment.

FIG. 22 is an alternative left perspective view of a sheet product package embodiment.

FIG. 23 is an right perspective view of a sheet product package embodiment.

FIG. 24 is an alternative right perspective view of a sheet product package embodiment, after sheet product has been dispensed.

FIG. 25 is an alternative right perspective view of a sheet product package embodiment, after sheet product has been dispensed.

FIG. 26 is a right perspective view of an alternative sheet product package embodiment.

FIG. 27 is an alternative top perspective view of a sheet product package embodiment.

FIG. 28 is an alternative front perspective view of a sheet product package embodiment.

FIG. 29 is a front and front perspective view of a core engagement system for use in a sheet product package.

FIG. 30 is a front perspective and front view of an alternative core engagement system for use in a sheet product package.

FIG. 31 is a front view of a sheet product refill dispenser.

FIG. 32 is a top view of a sheet product package dispenser in a drawer.

FIG. 33 is a front view illustrating alternative orientations during use of an exemplary sheet product package.

FIG. 34 is a front view illustrating loading a refill into a sheet product package embodiment.

FIG. 35 is a front view illustrating the activation of a sheet product package embodiment and the initiation of dispensing thereby.

FIG. 36 illustrates the dispensing of a sheet product by a sheet product package embodiment and the activation of an cutting means therein.

FIG. 37 illustrates an alternative cutting means activation method.

FIG. 38 illustrates an end of roll warning indicator employed in a sheet product package embodiment.

FIG. 39 illustrates a front perspective view of a sheet product package embodiment.

FIG. 40 illustrates a top view of a sheet product package embodiment.

FIG. 41 illustrates a front view of a sheet product package embodiment.

FIG. 42 illustrates alternative orientations during use of an exemplary sheet product package.

FIG. 43 illustrates the opening of a sheet product package embodiment prior to loading of a refill therein.

FIG. 44 illustrates the loading of a sheet product into a sheet product package embodiment.

FIG. 45 illustrates dispensing of a sheet product using an exemplary sheet product package.

FIG. 46 is a side perspective view of an exemplary sheet product package.

FIG. 47 is a front perspective view of an exemplary sheet product package.

FIG. 48 is a top view of an exemplary sheet product package.

FIG. 49 is a top view illustrating a sheet product package dispenser embodiment in a drawer.

FIG. 50 illustrates loading a refill into an exemplary sheet product package embodiment.

FIG. 51 is a top perspective view illustrating the initiation of sheet product dispensing by squeezing a sheet product package embodiment.

FIG. 52 illustrates dispensing a sheet product from a sheet product package embodiment.

FIG. 53 illustrates an exemplary orientation of a sheet product package during use.

FIG. 54 illustrates an exemplary end of roll indicator imprinted or embossed on an exemplary sheet product.

FIG. 55 illustrates an exemplary advertising method employing advertisements embossed in or otherwise associated with a sheet product core.

FIG. 56 illustrates an exemplary merchandising method for sheet product refills.

FIG. 57 illustrates the use of an exemplary plastic overwrap to protect a sheet product.

FIG. 58 illustrates an exemplary sheet product package capable of supporting a non-round sheet product roll.

FIG. 59 illustrates an exemplary sheet product dispensing business method.

FIG. 60 illustrates an exemplary hinged loading mechanism for expanding a non-round sheet product roll.

FIG. 61 illustrates an exemplary, spring-loaded tensioning means for controlling the dispensing of sheet products from a non-round sheet product roll.

FIGS. 62, 62A and 62B illustrate exemplary, cammed dispensing means for controlling the dispensing of sheet products from a non-round sheet product refill.

FIG. 63 illustrates an exemplary keyed rotational hinge.

### DETAILED DESCRIPTION OF EMBODIMENTS

Reference will now be made in detail to embodiments of the present invention, examples of which are illustrated in the accompanying drawings.

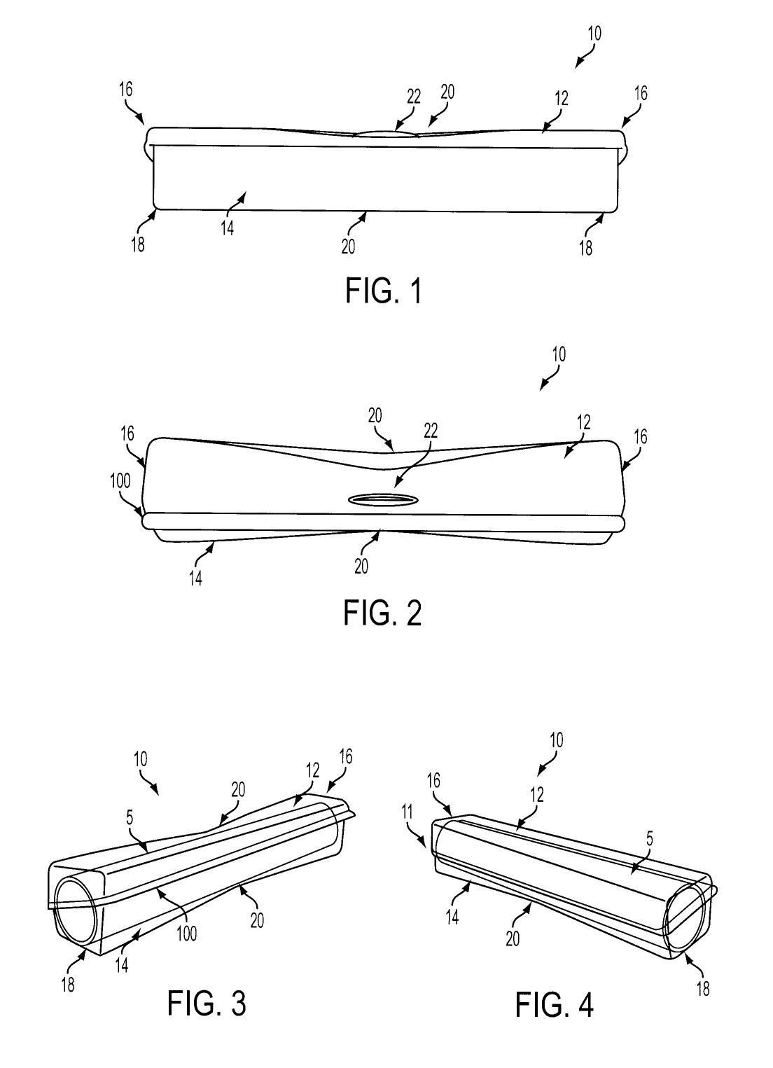

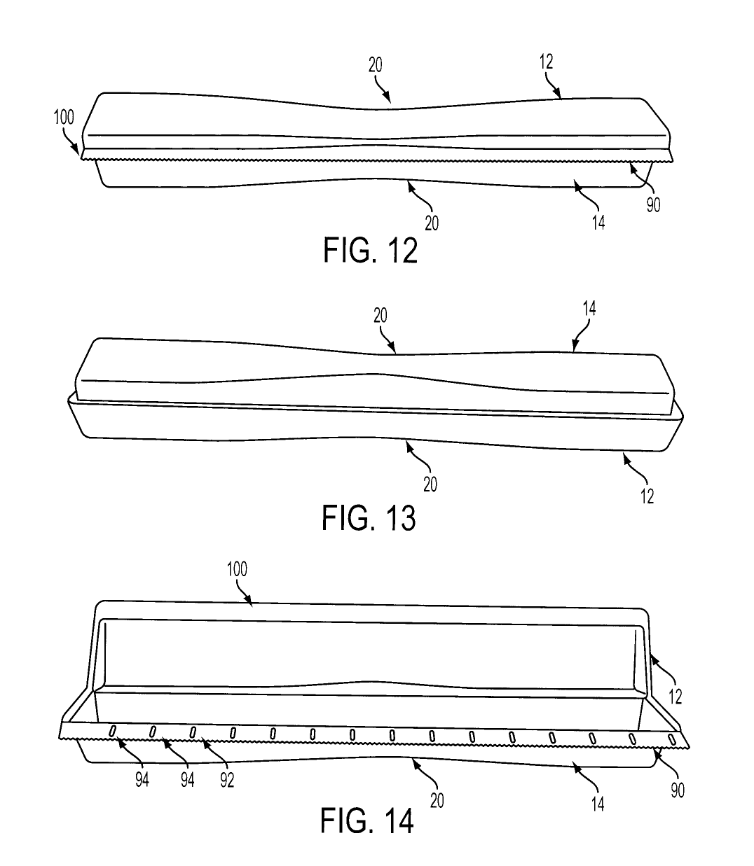

FIGS. 1 and 12 are front views of sheet product package embodiments, wherein package 10 is made of a transparent or translucent plastic, such as, without limitation, Polyethylene Terephthalate (“PET”), reprocessed PET (“RPET”), Polyvinyl Chloride (“PVC”), polystyrene, polypropylene, Polyethylene Terephthalate Glycol (“PETG”), polyethylene, multilayered sheets which combine several different plastics, or combinations thereof. In one embodiment, package 10 may be recycled after sheet product 5 has been dispensed from package 10. The transparent or translucent plastic comprising package 10 may be clear or colored depending on specific needs. Package 10 may also include labels affixed or embedded into to any of the surfaces thereof. By way of example, without limitation, such embedded labels may include reverse printed film which has been laminated to a plastic structure and incorporated into package 10. Such an arrangement can allow the label to resist scuffing, peeling, and the like. Labels may also be shrink wrapped around package 10, affixed thereto with adhesive, or information may be printed directly onto package 10. Package 10 may be treated with or coated with a material that facilitates printing or labeling, as is known in the art.

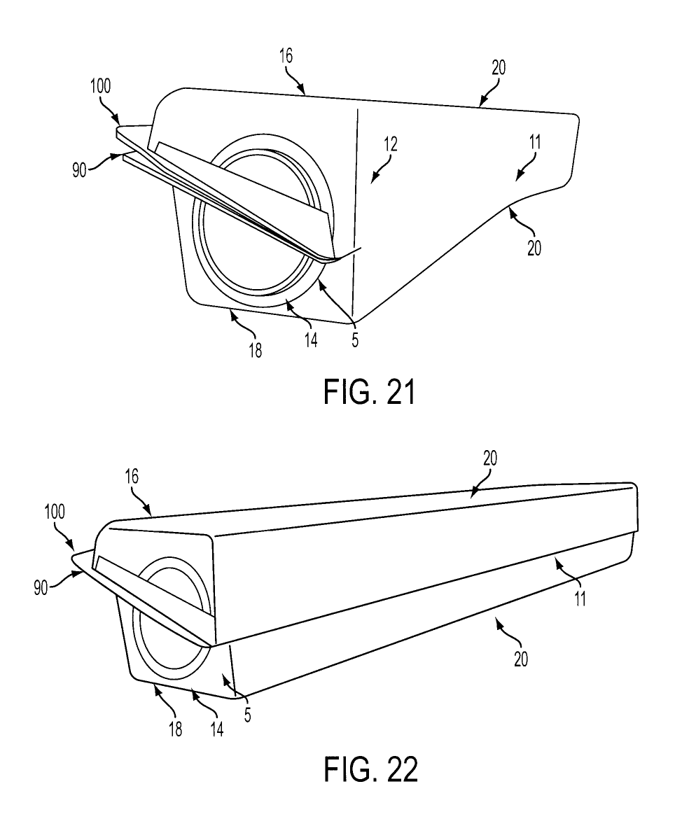

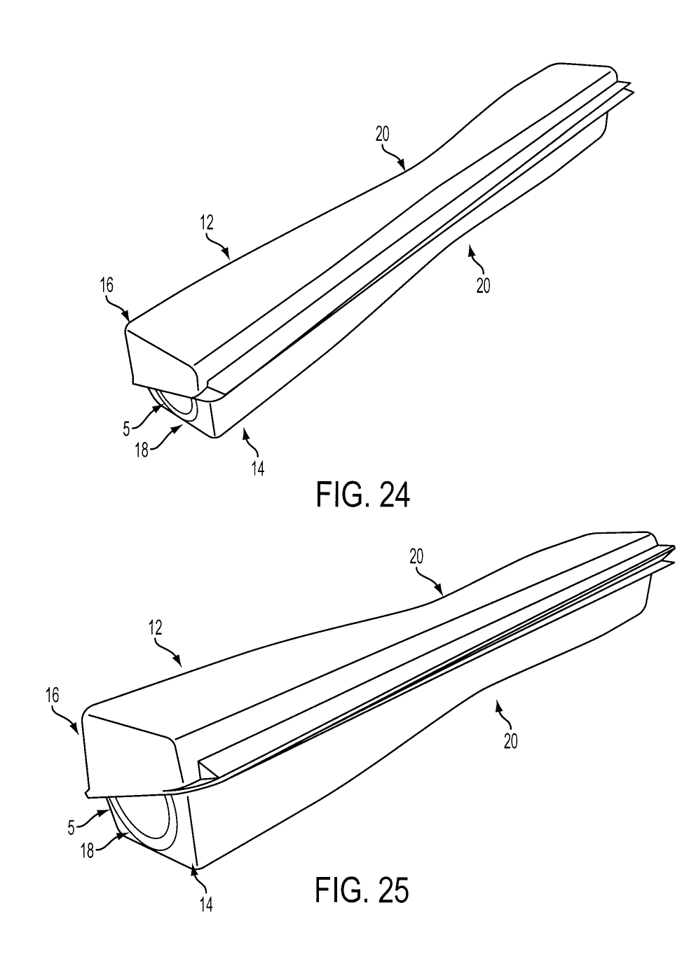

FIG. 2 is a top view of a sheet product package embodiment. FIGS. 2 and 21-25 illustrate the “hourglass” shape of a package embodiment, the hourglass shape being created in both lid 12 and base 14. The hourglass shape 20 makes package 10 easier and more comfortable to hold (i.e. more ergonomic) and gives the user a better grip on package 10, especially when package 10 is closed. In an embodiment, the front edge of lid 12 may not include an hourglass indent 20, or hourglass indent 20 may be reduced in scale in this region, thereby giving the user a larger surface area with which to apply pressure to lid 12 proximate to cutting edge 90. An example of such an embodiment is illustrated in more detail in FIG. 8. In addition, one or more thumb ridge(s) 22 may be incorporated into lid 12 to facilitate opening lid 12 or other operation of package 10.

Despite the generally hourglass shape of package 10, at least portions of the left-hand and right-hand edges of the top and/or bottom surfaces of package 10 may be flat, thereby allowing multiple packages to be stacked, such as on a grocery store shelf or in a pantry. In an embodiment (not illustrated), top surface 16 and bottom surface 18 may comprise corresponding male and female detents. Such detents can permit one package to be more securely stacked on top of another. The detents may be designed such that they do not form a positive mate between the packages, thereby permitting the uppermost package to be more easily removed from the stack. In an embodiment, top surface 16 and/or bottom surface 18 may be coated with or otherwise comprise a non-slip material or texture, thereby permitting packages 10 to be easily stacked. Such non-slip material or texture may be achieved through means known in the art, including, without limitation the use of various coatings, additives to the plastic, inks, labels, or surface conditioning techniques.

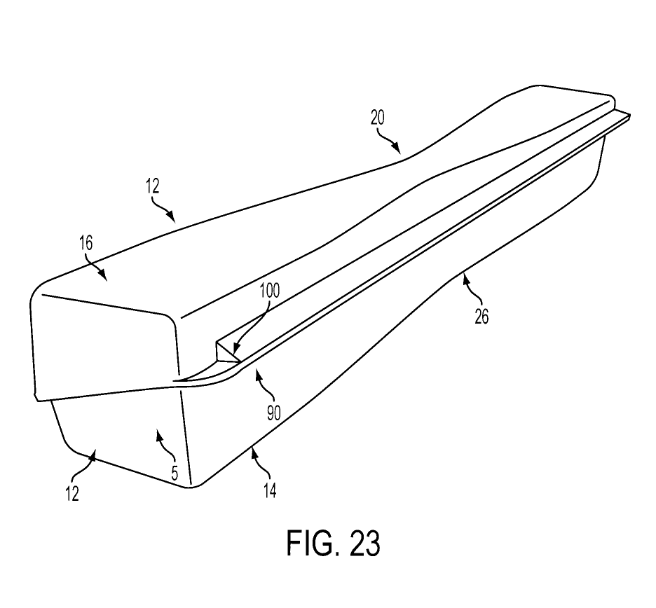

FIGS. 3 and 23 are front perspective views of an embodiment of package 10. In this embodiment, sheet product 5 can be seen more clearly through package 10.

FIGS. 4, 21, and 22 are rear perspective views of a sheet product package embodiment which illustrate hinge 11. In an embodiment, hinge 11 extends along at least a portion of the joint between lid 12 and base 14 at the back of package 10. In an embodiment, hinge 11 permits lid 12 to be opened and closed without necessitating the removal of lid 12 from package 10. A portion of hinge 11 may be removed proximate to hourglass indent 20, thereby improving the ergonomics of package 10. In an embodiment, at least a portion of hinge 11 may comprise a thin, flexible film that is adhered to at least one of lid 12 and/or base 14, thereby permitting hinge 11 to be relatively flat when package 10 is closed. In another embodiment, the package is molded in one piece with a “living hinge”, as is known in the art. In another embodiment, the package is molded such that a multiple piece, snap hinge is formed. Alternative hinge designs may also be substituted therefor without departing from the spirit or the scope of the disclosure.

In an embodiment, lid 12 is designed to return to the closed position when not in use. This can be accomplished through a variety of means, including, without limitation, by providing additional weight to lid 12 near the front, by manufacturing hinge 11 such that it has a “memory”, by attaching lid 12 to base 14 with one or more disengagable elastic bands, as well as by combinations thereof.

In some embodiments, lid 12 and base 14 positively engage, thereby reducing the likelihood of lid 12 accidentally opening. Such positive engagement can be accomplished through a variety of means, including, without limitation, providing lid 12 and base 14 with one or more mating detents, and embedding one or more rare earth magnets in lid 12 and base 14.

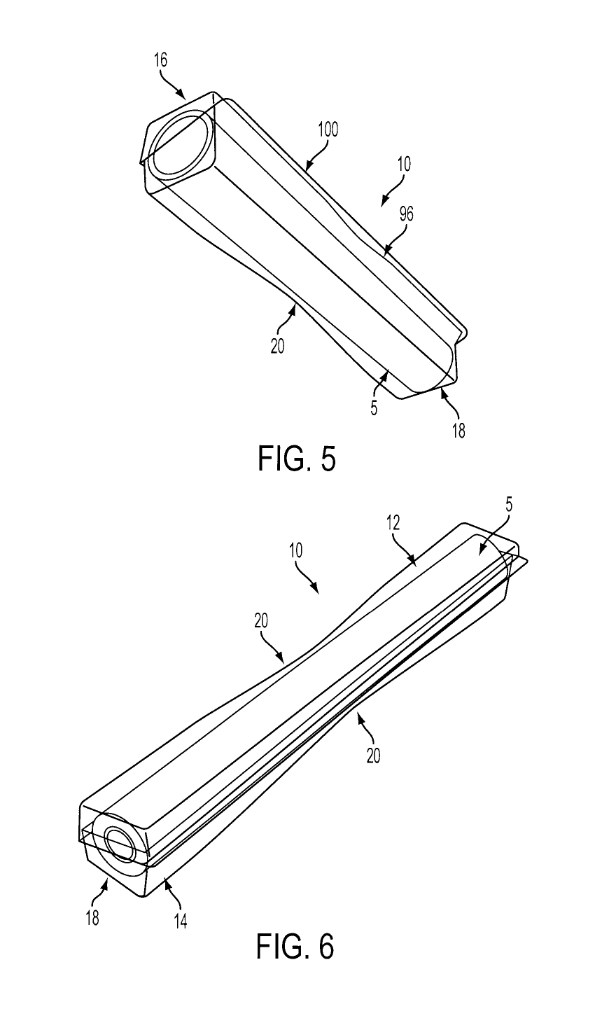

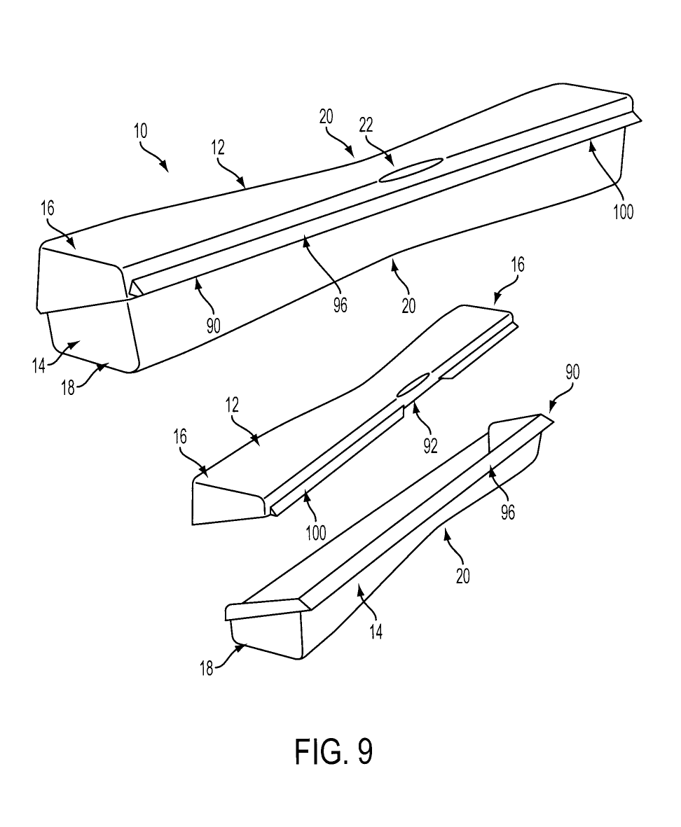

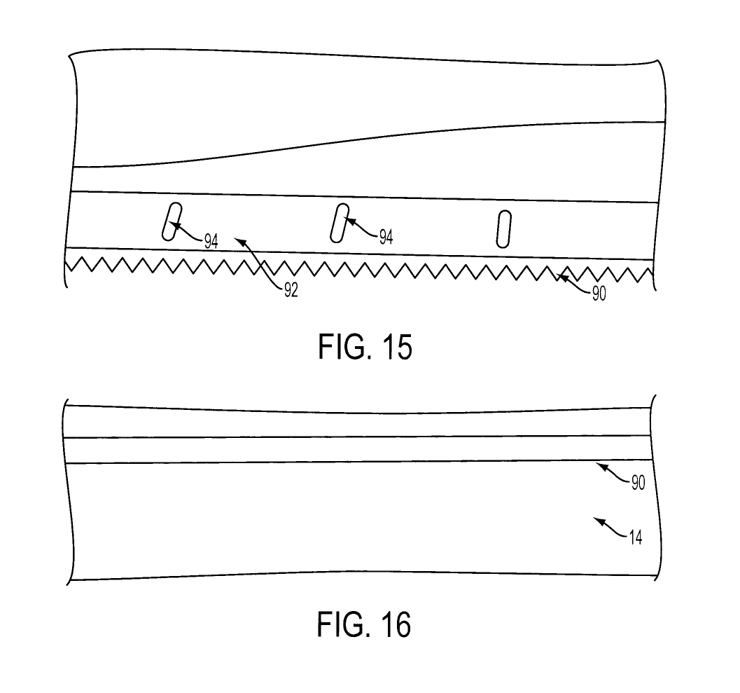

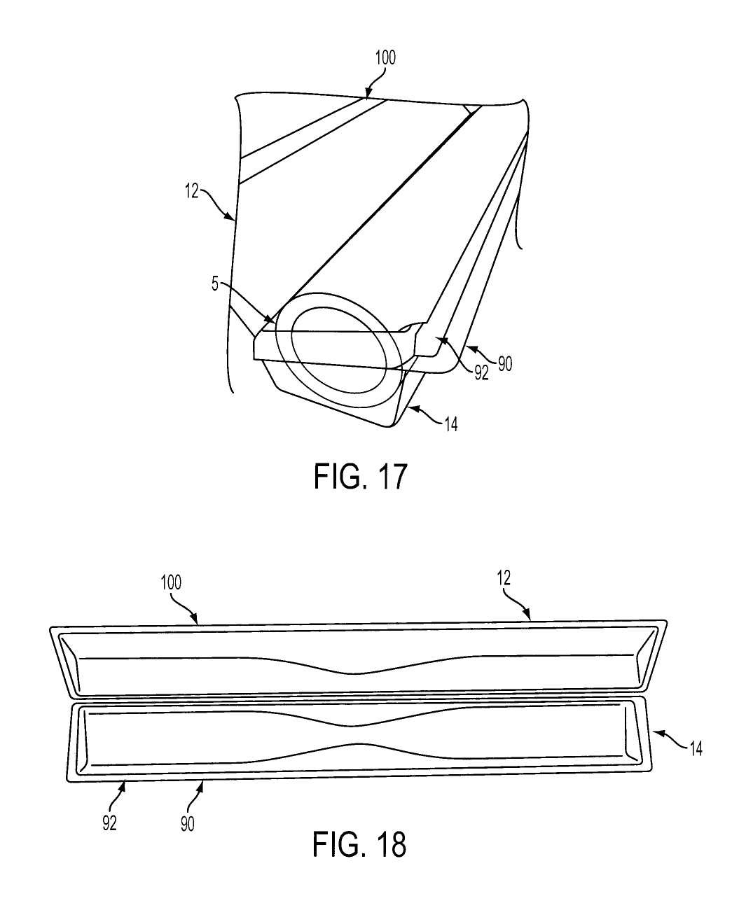

FIGS. 5 and 13 are bottom perspective views of sheet product package embodiments. As illustrated in additional detail in FIGS. 9 and 15-17, embodiments of package 10 include cutting edge 90 which is aligned with the cutting teeth in a substantially horizontal arrangement, and wherein a small flange 92 is provided between cutting edge 90 and the bottom of base 14. Flange 92 may comprise one or more reinforcing ribs 94, which add additional strength to flange 92.

Although cutting edge 90 is described herein as substantially horizontal, alternative cutting edge embodiments, including, without limitation, a substantially vertical cutting edge, can be substituted therefor without departing from the spirit or the scope of this disclosure. Cutting edge 90 can be manufactured as part of base 14, or may be a separately manufactured part that is attached to base 14 during the manufacturing process. Cutting edge 90 may extend along the length of base 16, or may be comprised of a plurality of components with at least one gap. Although cutting edge 90 is described herein as incorporated into base 14, it should be apparent to one skilled in the art that cutting edge 14 can be incorporated into lid 12 without departing from the spirit or the scope of the disclosure.

Cutting edge cover 100 may cover at least a portion of cutting edge 90 when lid 12 is closed, thereby protecting the integrity of the cutting edge. By way of example, without limitation, cutting edge cover 100 may comprise a single, flat piece of material that extends beyond cutting edge 90, or cutting edge cover 100 may comprise a piece of material that is cantilevered over cutting edge 90.

When lid 12 is closed and positively engaged with base 14, cutting edge cover 100 can exert enough force on the portion of sheet product 5 in that is in contact with the flange that sheet product 5 is less likely to slip back into base 14 after sheet product 5 has been cut. Cutting edge cover 100 may also include at least one recess 96, whereby the user can easily grasp sheet product 5 as sheet product 5 rests on the flange. In an embodiment employing at least one gap in cutting edge 90, the gap may be aligned with cutting edge cover recess 96.

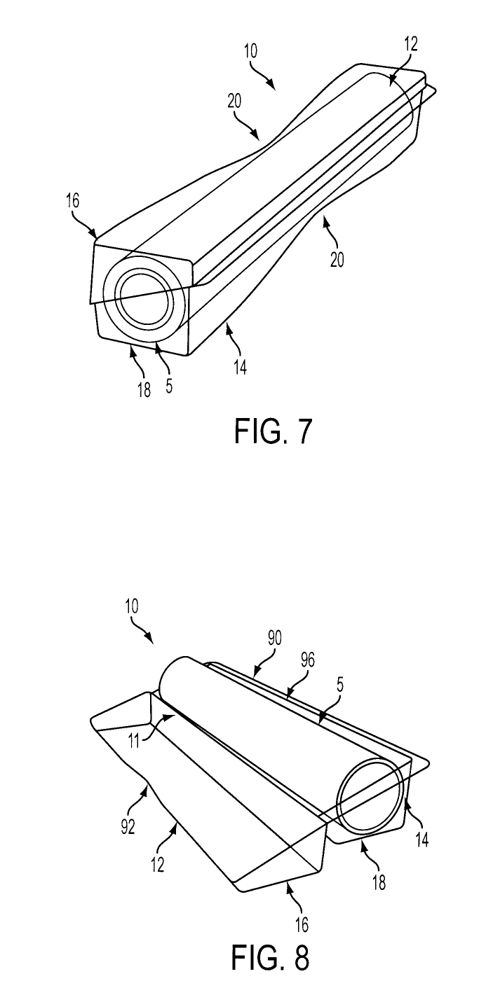

As FIGS. 6 and 7 illustrate, embodiments of sheet product package 10 can be manufactured to accommodate a wide variety of sheet product widths and lengths.

As illustrated in FIGS. 8, 14, and 18, lid 12 can be opened, thereby permitting easy access to the entirety of sheet product 5. Where sheet product 5 is provided in roll form, the roll can be easily handled, thereby permitting the sheet product to be easily “rewound” onto the roll and permitting replacements or “refills” therefor to be easily inserted therein.

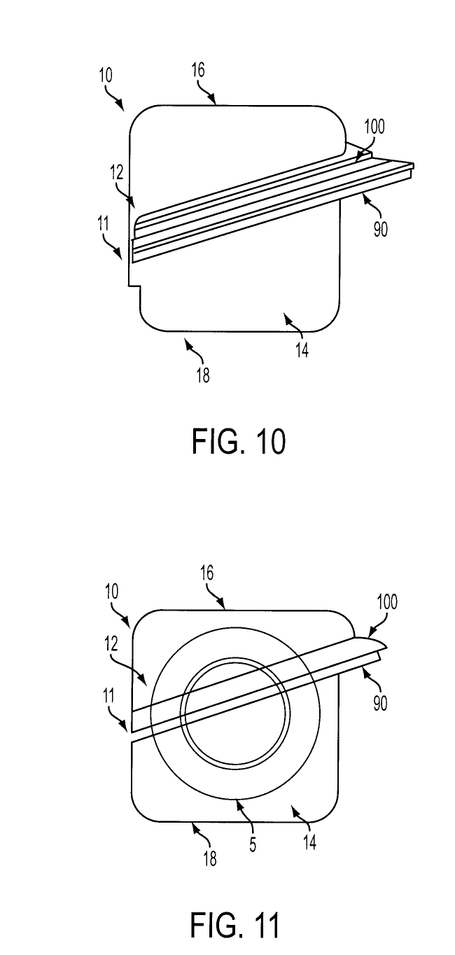

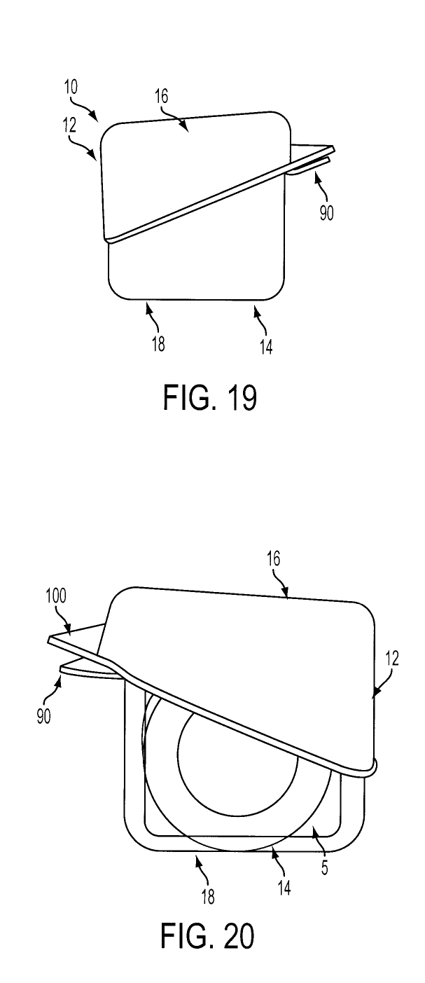

As FIGS. 10, 11, 19, and 20 illustrate, embodiments of package 10 can allow sheet product 5 to rest along at least a portion of the bottom of base 14. This permits sheet product 5 to be easy to reach for the next use. Although described herein as predominantly distributed in roll form, it should be apparent to one skilled in the art that alternative sheet product distribution arrangements may be substituted therefor without departing from the spirit or the scope of the invention.

A means for engaging and holding the core on which the sheet product is rolled may also be incorporated into the package such that the roll of sheet product will not fall out of the package during dispensing, or if the package is inadvertently turned upside down while open.

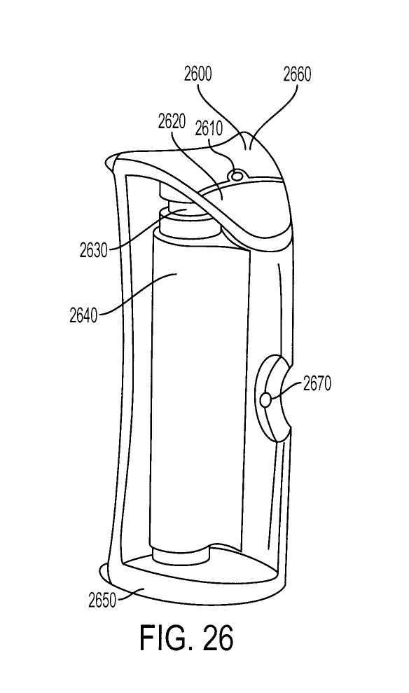

FIGS. 26-28 illustrate alternative sheet product package embodiments which are capable of accepting sheet product package refills. That is, unlike traditional sheet product packaging which incorporates the sheet product therein and which is discarded after the supply of sheet product has been depleted, in the package illustrated in FIGS. 26-28, any remaining sheet product and/or any core around which the sheet product is wound can be readily removed therefrom and a new sheet product roll or other sheet product refill can be inserted therein. Distribution of sheet products as refills can be advantageous as it reduces the amount of packaging waste associated with the distribution and use of sheet products.

In the embodiments illustrated in FIGS. 26-28, sheet product 2640 is dispensed from sheet product package 2600 by way of a motor 2630. In the illustrated embodiments, sheet product package 2600 further comprises a motion sensor 2670, such as, without limitation, an ultrasonic motion sensor or other motion sensors known in the art. When a hand or other object is waived in front of motion sensor 2670, the sensor detects the motion and activates motor 2630. In some embodiments, when a user activates motor 2630, motor 2630 causes a predetermined length of sheet product 2640 to be dispensed. By way of example, without limitation, two inches of sheet product 2640 may be dispensed by sheet product package 2600, such that there is sufficient surface area to permit the user to grasp the dispensed sheet product. At the end of the dispensing cycle, in some embodiments motor 2630 allows sheet product 2640 to spin relatively freely, such that the user can easily dispense the desired amount. In some embodiments, motor 2630 may continue to dispense sheet product 2640 until the user activates one of motion sensor 2670 or buttons 2660 and 2620.

In some embodiments, once the desired amount of sheet product has been dispensed, the user can activate cutter button 2620, which causes a cutter to sever the dispensed portion of sheet product 2640 from the remainder thereof. Such a cutter may be mechanically coupled to cutter button 2620, or may be electronically operated.

In some embodiments, motor 2630 and other functions of sheet product package 2600 may be electronically activated. Such electronic activation can be powered by a variety of means, including via standard household current, as is known in the art for kitchen appliances, as well as battery and solar power. In embodiments employing battery and/or solar power, it may be advantageous to locate the batteries in base 2650, thereby providing additional weight to the base. Such additional weighting can allow sheet product package 2600 to work in both a horizontal and vertical orientation, as described below. Additional weight may also be added to further stabilize sheet product package 2600.

In some embodiments, sheet product package 2600 may further comprise an end of roll indicator 2610. To facilitate the operation of such an end of roll indicator, product package 2600 may include electronic circuitry capable of reading a barcode, radio frequency identification tag, ferromagnetic strip, or other indicator to determine the length of sheet product contained in a refill when new, and monitor the amount of sheet product dispensed. In alternative embodiments, mechanical means, such as an arm that maintains enough pressure on the refill to sense the diameter of the refill, may be substituted for the electronic circuitry. When sheet product package 2600 determines that a limited supply of sheet product 2360 remains, sheet product package 2600 can cause end of roll indicator 2610 to be constantly illuminated, flash, or otherwise provide visual, audio, tactile, or other sensory feedback to the user, as illustrated in FIG. 38.

In some embodiments, buttons 2620 and 2660 may also facilitate other functionality, such as turning sheet product package 2600 on and off. By way of example, without limitation, prolonged activation of button 2620 may turn off sheet product package 2600, such that objects in a drawer in which sheet product package 2600 is stored cannot cause sheet product package 2600 to dispense unwanted sheet products.

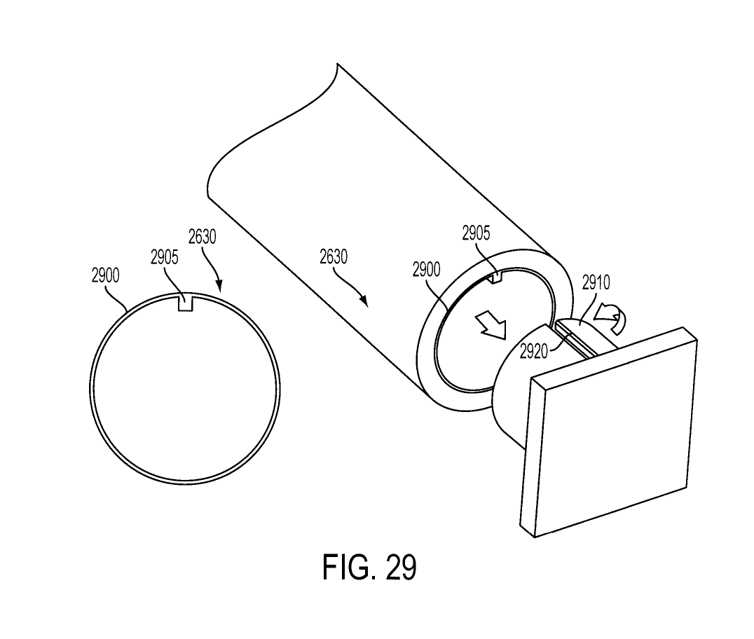

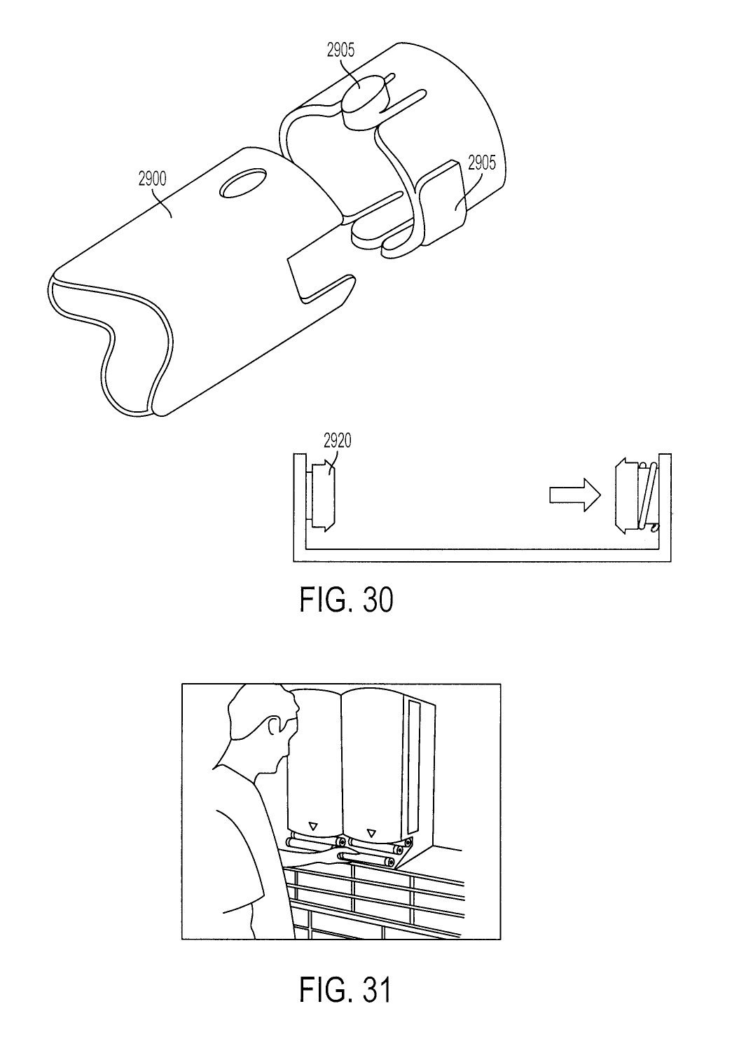

FIGS. 29 and 30 illustrate alternative core engagement systems for use in a sheet product package. In some embodiments, sheet product 2630 can be dispensed on a core 2900 which incorporates one or more protrusions and/or detents 2905. Such detents and/or protrusions may mate with corresponding detents and/or protrusions 2920 in hinge 2910. Hinge 2920 can allow sheet product 2630 to easily rotate within sheet product package 2630, thereby facilitating the dispensing thereof.

In some embodiments, the detents and/or protrusions 2905 may be incorporated into one or more endcaps that are placed in or attached to the refill. Such embodiments can allow coreless sheet product refills to be used in sheet product packages.

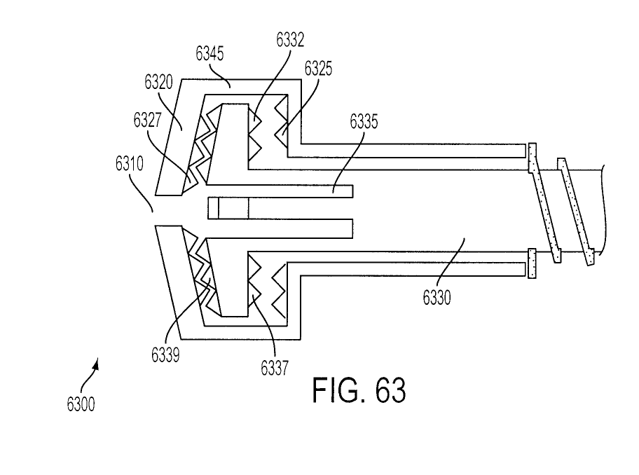

In some embodiments, hinge 2910 may incorporate a locking means, such that hinge 2910 does not rotate unless detents and/or protrusions 2920 are appropriately activated. By way of example, in FIG. 63, hinge 6300 comprises cap 6320 and stem 6330. Stem 6330 may comprise one or more slots 6335 and fingers such that an end of stem 6630 can be inserted into and positively mated with cap 6320. Stem 6330 may further comprise one or more springs which positively biases cap 6320 against stem 6330 when in a fully extended position. When in the fully extended position, teeth 6325 inside cap 6320 mate with corresponding teeth 6332 of fingers 6337, thereby restricting the rotation of cap 6320. When a standard sheet product refill is inserted into a sheet product package employing cap 6320 and stem 6630, the refill adds pressure to the spring, thereby causing cap 6320 to slide along stem 6630. Due to the shape of cap 6320, the standard refill causes cap 6320 to overextend and teeth 6327 engage teeth 6339 of fingers 6337. By contrast, when a refill according to an embodiment of the instant key-and-lock mechanism is employed, the detents inside the core around which the sheet product is wound, or a similarly shaped endcap fitted into the core or directly into the sheet product, engage fingers 6337 and cause them to be retracted sufficiently to allow free rotation of cap 6320. It should be apparent that alternative key and lock mechanisms may be substituted for the key and lock mechanism illustrated in FIG. 63 without departing from the spirit or the scope of the invention. Embodiments employing such a key-and-lock configuration can limit the refills that can be used with sheet product package 2600, thereby ensuring only high-quality and appropriately designed sheet products are dispensed therefrom.

FIG. 31 is a front view of a sheet product refill dispenser according to an embodiment. In FIG. 31, the refills are contained in a gravity-fed dispenser, which allows consumers to easily grasp the refill. The dispenser also provides significant surface area over which to present various marketing materials.

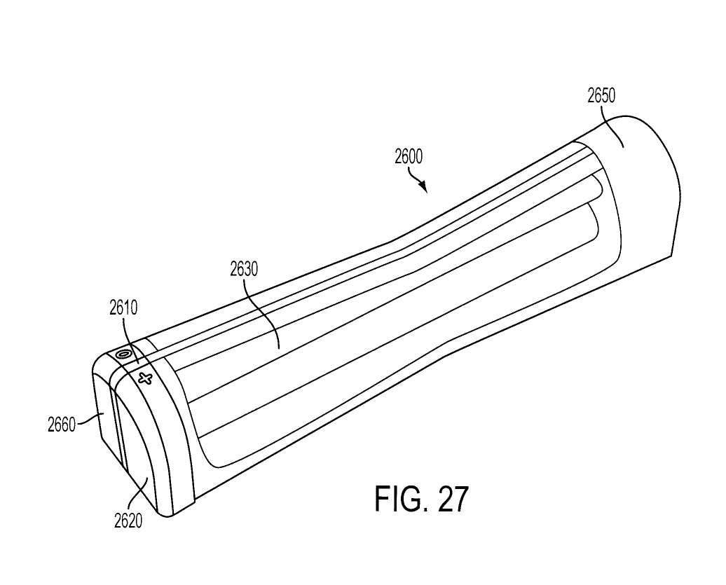

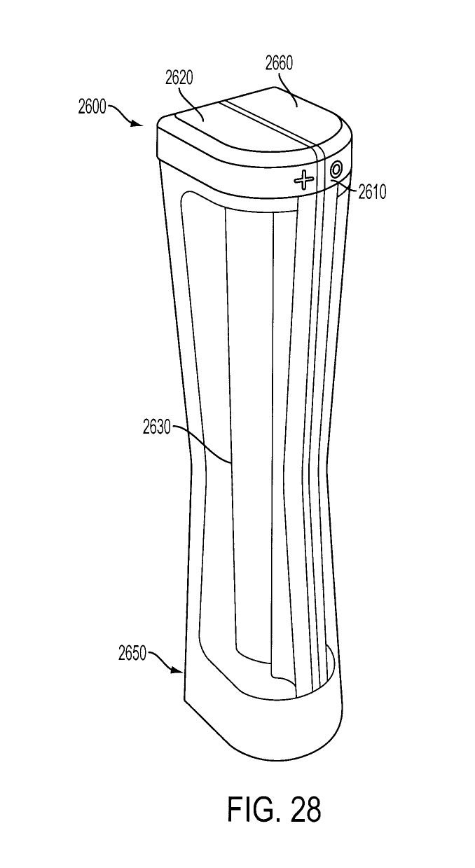

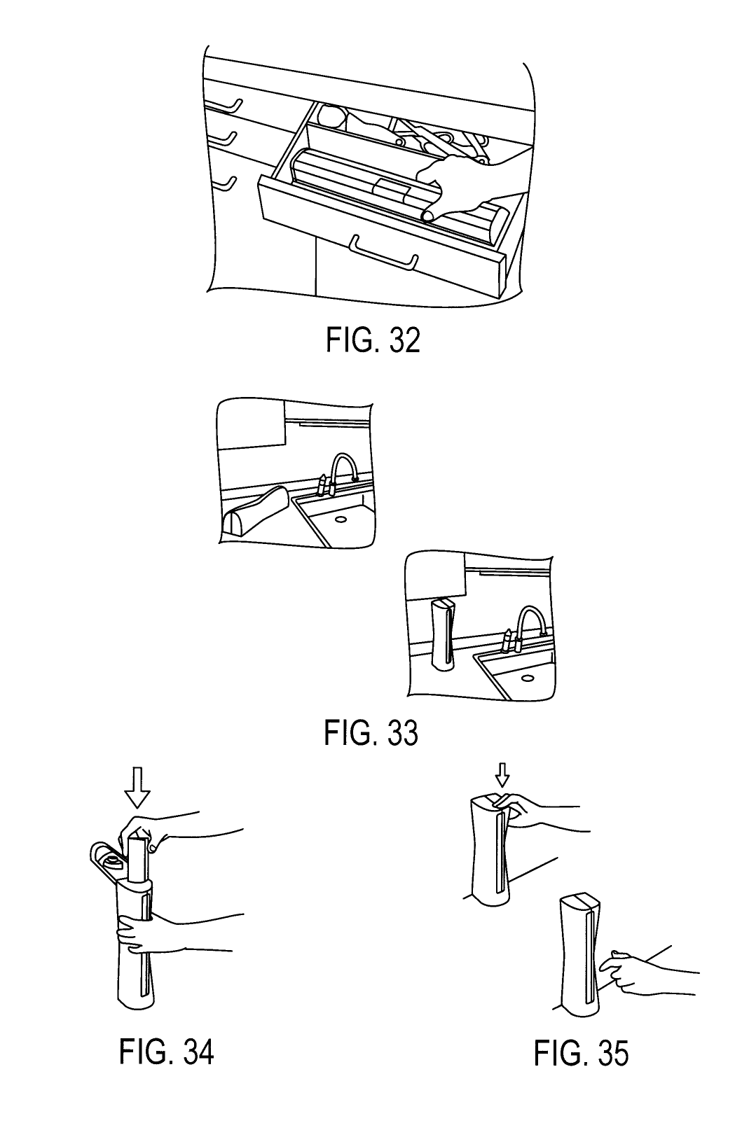

FIG. 32 is a top view of the sheet product package dispenser of FIGS. 27 and 28 in a drawer. In some embodiments, sheet product package dispenser 2600 is sufficiently small to be placed in a traditional drawer, thereby freeing counter space for other purposes. In some embodiments, sheet product package dispenser 2600 may comprise stainless steel, aluminum, or other metallic accents, thereby giving sheet product package dispenser an appealing appearance, such that sheet product package dispenser 2600 is suitable for display on a counter like other appliances.

FIG. 33 is a front view illustrating alternative orientations during use of an exemplary sheet product package. In some embodiments, sheet product package 2600 may be weighted and shaped such that it remains stable whether in a horizontal or vertical orientation.

FIG. 34 is a front view illustrating loading a refill into a sheet product package embodiment. In the embodiment illustrated in FIG. 34, the refill is simply slid into the sheet product package, and the lid is closed. Electronics within the sheet product package automatically advances the roll until it is capable of being dispensed. An indicator light may flash rapidly, glow an alternative color, or provide other indicia in the even that dispensing of the sheet product cannot be properly initiated.

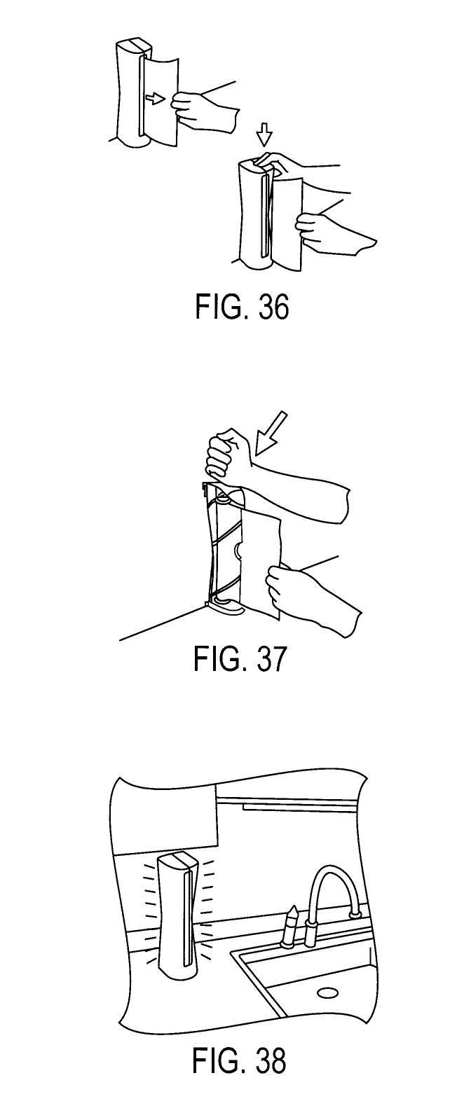

FIG. 35 is a front view illustrating the activation of a sheet package dispenser embodiment and the initiation of dispensing thereby. As described above, in some embodiments the sheet product package may comprise one or more buttons. When appropriately activated, the sheet product package can advance the sheet product, such that the user can easily grasp the sheet product for dispensing. In some embodiments, the sheet product package continues to dispense the sheet product until one or more buttons is depressed, or until a motion sensor or other such device is activated, thereby indicating that the desired length of sheet product has been dispensed. Once the desired length of sheet product has been dispensed, the user can press another button to activate a cutting mechanism, which severs the dispensed sheet product. This cutting mechanism activation is illustrated in FIGS. 36 and 37.

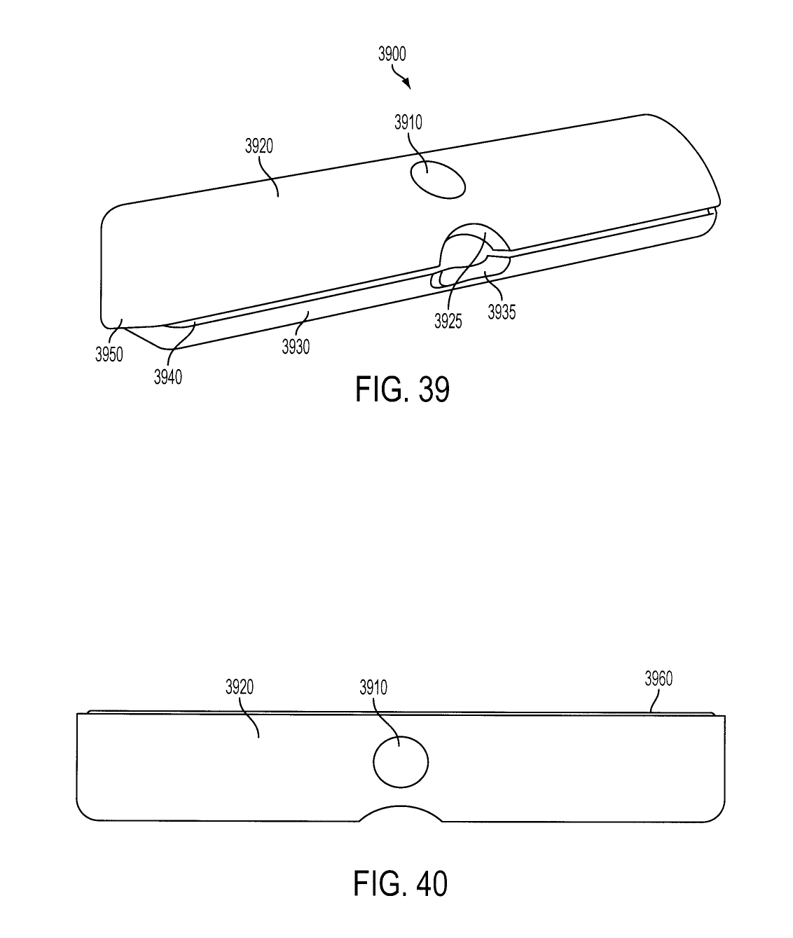

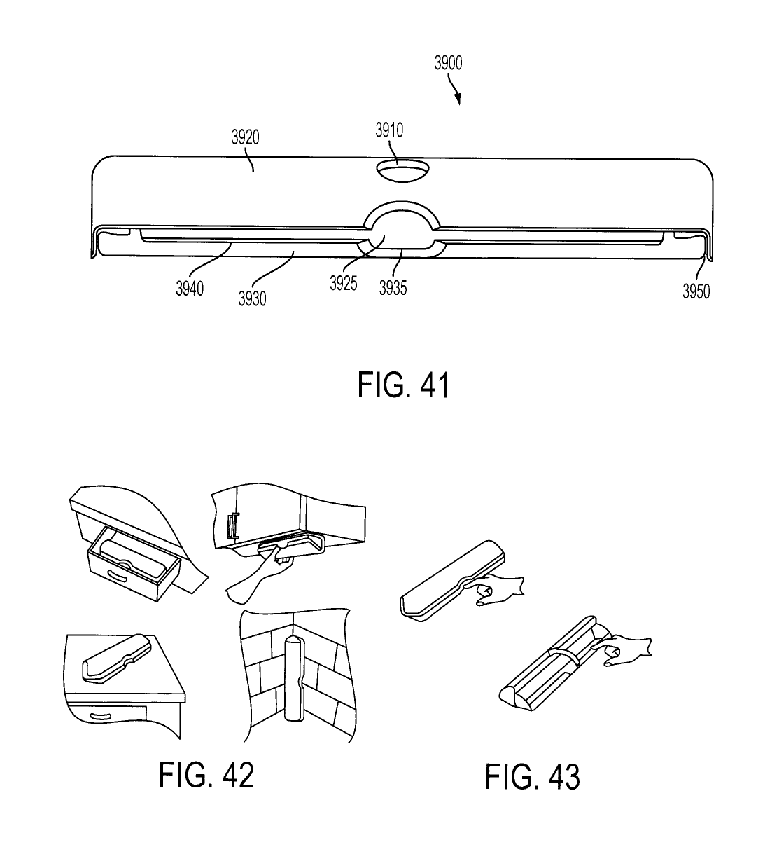

FIGS. 39 through 41 illustrate an alternative sheet product package embodiment. In the illustrated embodiments, sheet product package 3900 comprises two sections, lid 3920 and base 3930, which are joined by a hinge 3950. At least one detent and a mating protrusion are also incorporated into lid 3920 and base 3930, such that lid 3920 remains closed regardless of the orientation of sheet product package 3900. Although detents and protrusions are described herein as closing sheet product package 3900, it should be apparent to one skilled in the art that alternative closure means, such as, without limitation, magnetic, adhesive, or friction based closures may be substituted therefor without departing from the spirit or the scope of the disclosed sheet product package.

Lid 3920 and base 3950 further comprise corresponding indentations 2935 and 2935, respectively, which allow a user to grasp the sheet product contained within sheet product package 3900 when the user wishes to initiate dispensing thereof through dispensing slot 3940. Lid 3910 further comprises a sheet product viewing window 3910, which allows the user to see which type of sheet product is contained within package 3900 and to determine the amount of sheet product remaining in the package. Sheet product package 3900 further comprises a cutting surface conveniently hidden within the package.

Sheet product package 3900 further comprises an adhesive, magnetic, or other mounting means 3960 on at least one surface. As illustrated in FIG. 42, this allows sheet product package 3900 to be mounted in a convenient location such that it is readily accessible any time the user needs it, although in at least some embodiments sheet product package 3900 is sized to fit in a standard kitchen drawer.

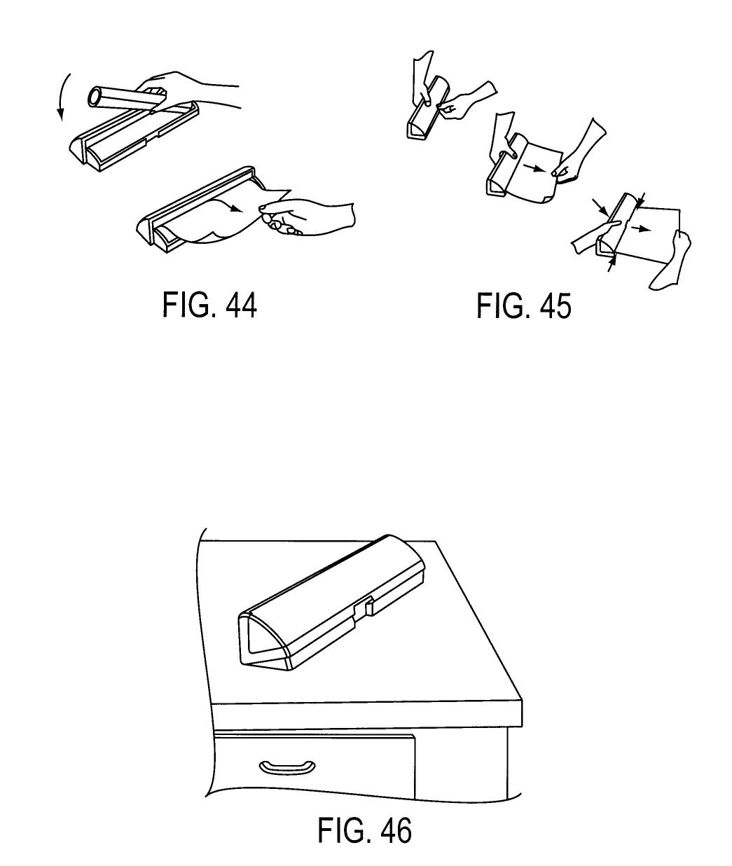

FIGS. 43-45 illustrate the insertion of a new sheet product refill and the dispensing of sheet product. In FIG. 43, to open sheet product package, the user simply lifts the lid with sufficient force to cause the lid to open. Once open, as illustrated in FIG. 44, the refill can be readily inserted in the sheet product package. The sheet product is advanced past the cutting blade or the corresponding anvil therefor, and the lid is closed. In FIG. 45, the user grasps an exposed section of the sheet product and dispenses a desired quantity of the sheet product. The user then simply depresses the lid, causing the cutting blade to perforate or sever the sheet product before or as it strikes the anvil. In FIG. 46, the user has dispensed the desired quantity of sheet product and has placed the sheet product package on the counter.

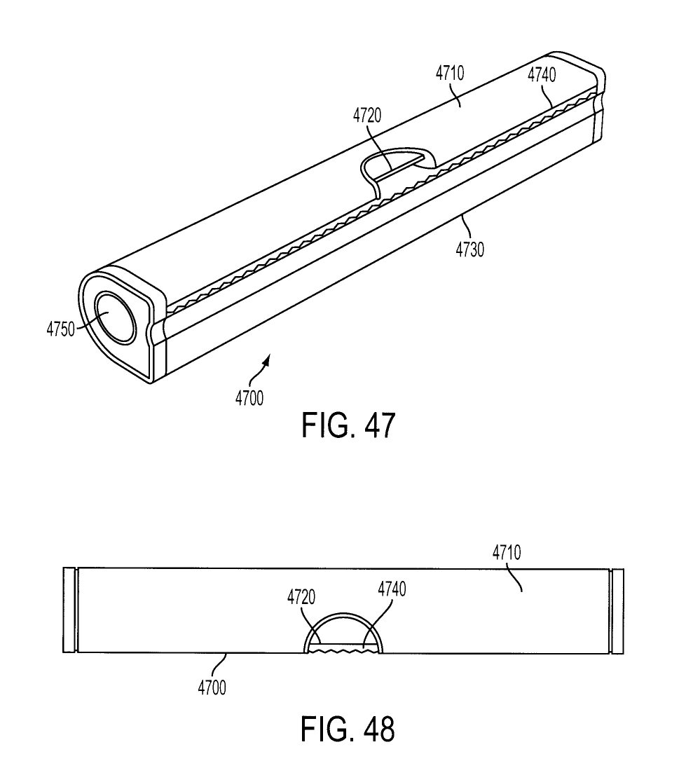

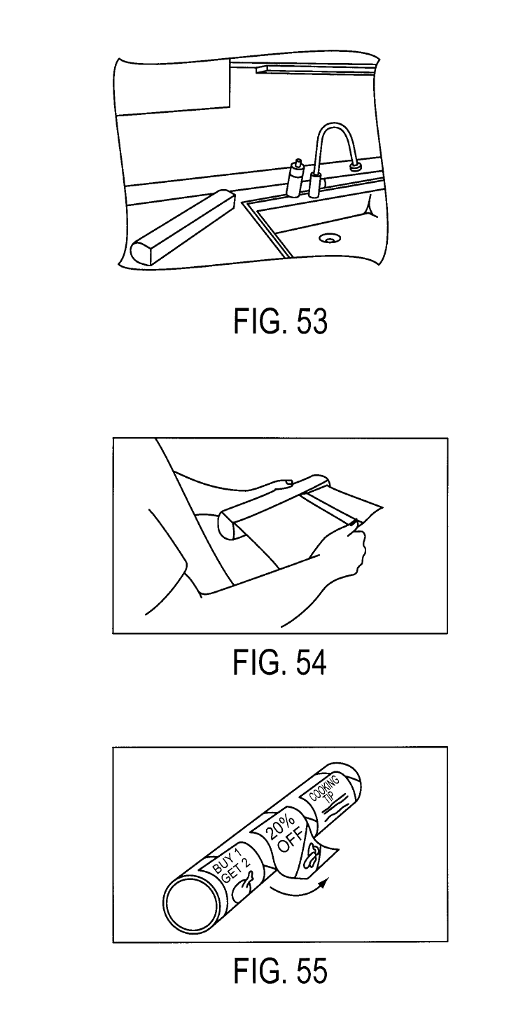

FIGS. 47, 48, and 53 illustrate an exemplary sheet product package. In this embodiment, sheet product package 4700 comprises a lid 4710 and base 4730, as well as two ends 4750. Lid 4710 and 4730 are joined by a hinge running substantially longitudinally along the length of sheet product package 4700, or at least a portion thereof. The ends comprise one or more rotating hinge means for facilitating the rotation of the sheet product within sheet product package 4700. Lid 4710 comprises one or more cut-out regions 4720 through which the user can grasp the sheet product when the user wishes to initiate dispensing thereof. In the illustrated embodiment, Lid 4710 can be weighted such that it naturally remains in a substantially closed orientation. In alternative embodiments, one or more closure means, such as those described above, may be employed to positively lock lid 4710 in the closed state.

Base 4730 comprises a soft-touch cutting edge 4740 made from a flexible rubber. Cutting edge 4740 may be integrated into or otherwise attached to base 4730. A flexible cutting edge can be advantageous in some embodiments as it allows the user to flex the front wall of base 4730, thereby further exposing the sheet product and making it easier for the user to grasp and to dispense the sheet product. This is illustrated in more detail in FIGS. 51 and 52.

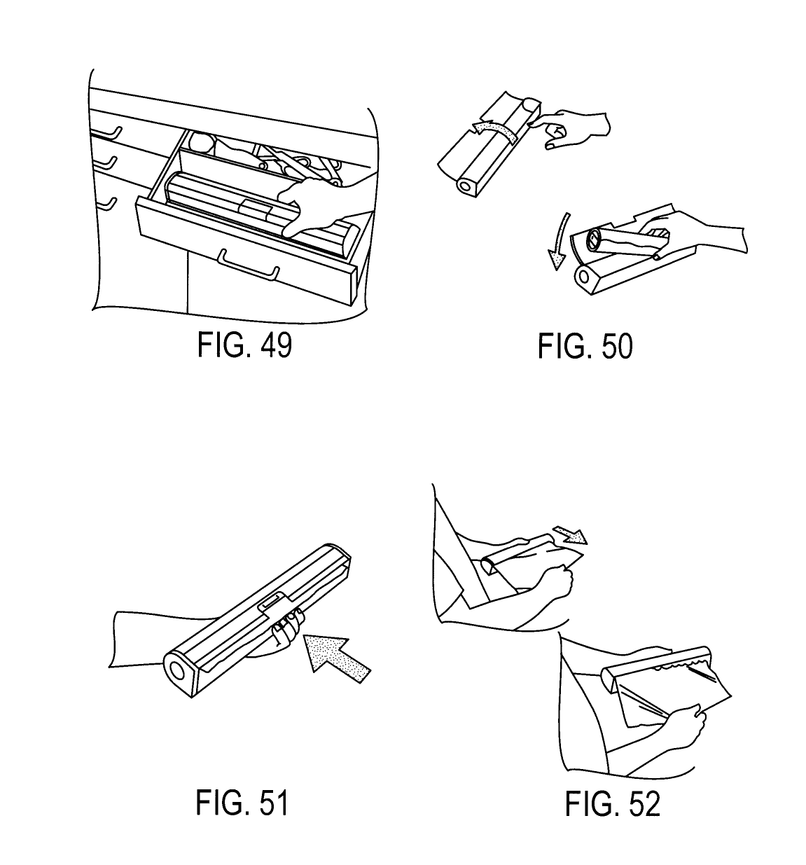

As FIG. 49 illustrates, the sheet product package may be of a size to easily fit in a kitchen drawer or other common storage area. As FIG. 50 illustrates, to install a refill the user simply opens the sheet product package and inserts the refill.

In some embodiments, such as that illustrated in FIG. 54, an end of roll indicia may be embossed in or imprinted on the sheet product such that the user can easily determine when a new sheet product refill is needed. Some embodiments further comprise coupons, recipes, or other marketing or promotional information removably attached to or imprinted on a core, or otherwise associated with a sheet product.

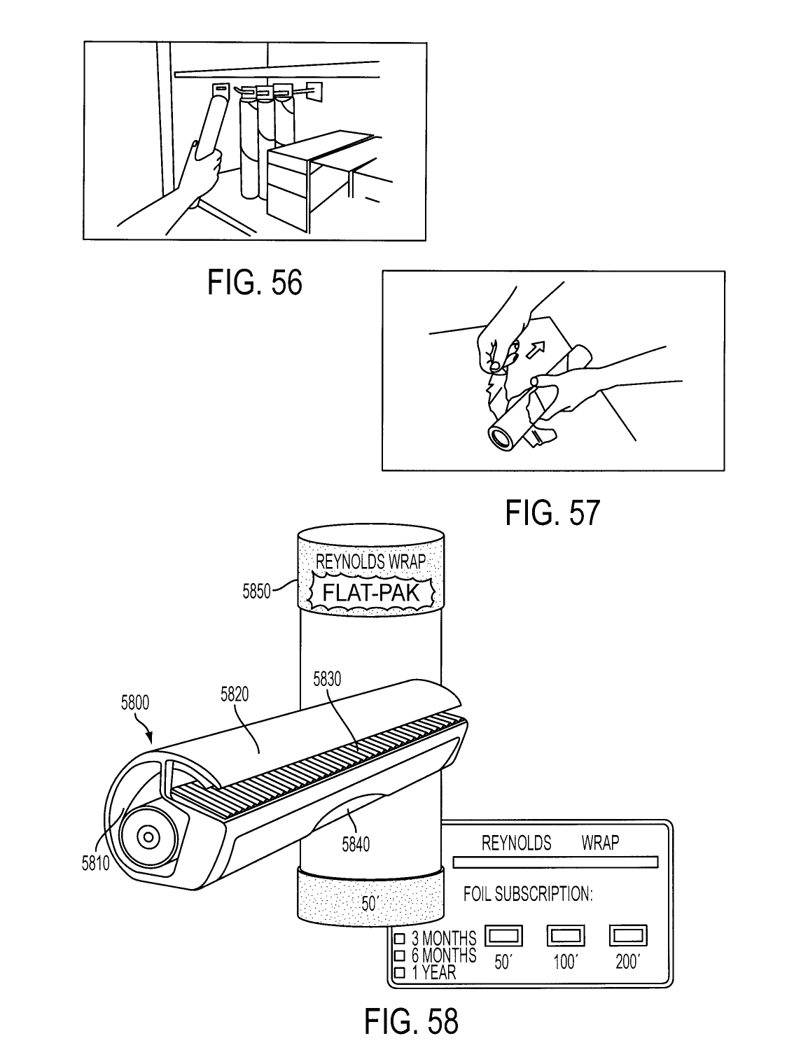

FIGS. 56 and 57 illustrate an exemplary sheet product refill merchandising system. In the illustrated system, the refills are individually packaged in a plastic overwrap or similar material which is attached to a hang tag made from plastic, cardboard, paperboard, or other such material. The hang tags allow the refills to be hung from one or more pegs on a grocery store shelf, thereby facilitating a visually unusual presentation of the refills.

In some embodiments, the sheet product package may be designed to fit non-round sheet product refills. By way of example, without limitation, non-round sheet product refills may have square, oval, triangular, or substantially flat geometries. FIG. 58 illustrates an exemplary sheet product package capable of supporting a non-round sheet product roll 5850. In the illustrated embodiment, sheet product package 5800 comprises lid 5820 which is hingedly attached to base 5840. A serrated or other cutting edge is also attached to base 5830 to facilitate cutting of the sheet product once a desired quantity has been dispensed. Sheet product package 5800 further comprises a transparent or translucent end 5810 which allows a user to easily determine the amount of sheet product remaining.

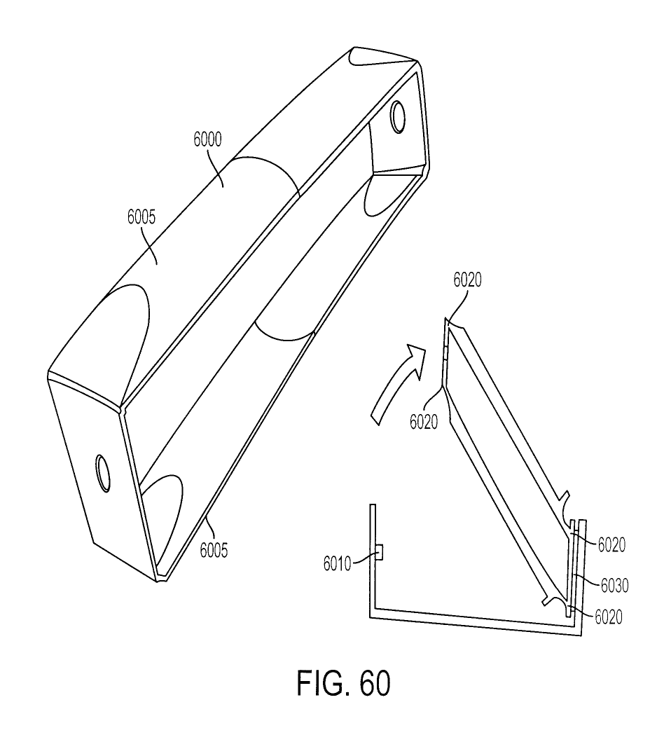

FIG. 60 illustrates an exemplary hinged mandrel 6000 capable of expanding a non-round refill into a substantially round shape. In the fully engaged position, hinged loading system comprises two rigid walls 6005 separated by a fixed distance. However, when the refill is to be loaded into the sheet product dispenser, a first end of hinged mandrel 6000 is disengaged from mating protrusion 6010. As the first end is raised, hinges 6020 articulate, and although walls 6005 remain substantially coplanar, they become more proximate than when in the fully engaged position. This new orientation allows walls 6005 to slide into the sheet product. The sheet product and walls are then returned to the fully engaged position. As walls 6005 expand, they exert pressure on the refill, causing the refill to become more rounded. An advantage of a more rounded refill is that it dispenses more smoothly than refills having more severe angles, such as, without limitation, square, triangular, and substantially flat refills.

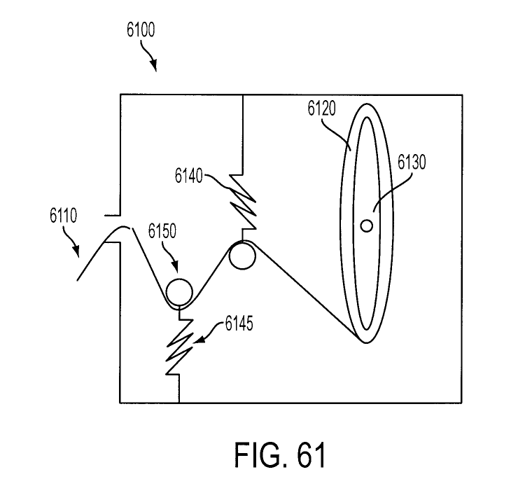

FIG. 61 illustrates a set of spring loaded tensioners 6140 and 6145 which help to dampen out the rougher feel associated with dispensing from non-round refills. Such tensioners may be used in addition to or in place of the other damping means disclosed herein. Such tensioners may comprise a roller over which sheet product 6110 can pass prior to dispensing from sheet product package 6100. In FIG. 61, as the non-round sheet product refill 6120 rotates around a central hinge, the sheet product 6110 can pass over tensioner 6140 which, in the illustrated embodiment, exerts upward force on the sheet product. As sheet product 6110 continues along the dispensing path, it may encounter one or more additional tensioners, such as tensioner 6145 which, in the illustrated embodiment, provides downward tension on sheet product 6110. The combined force from the tensioners can be sufficient to overcome the uneven dispensing feel.

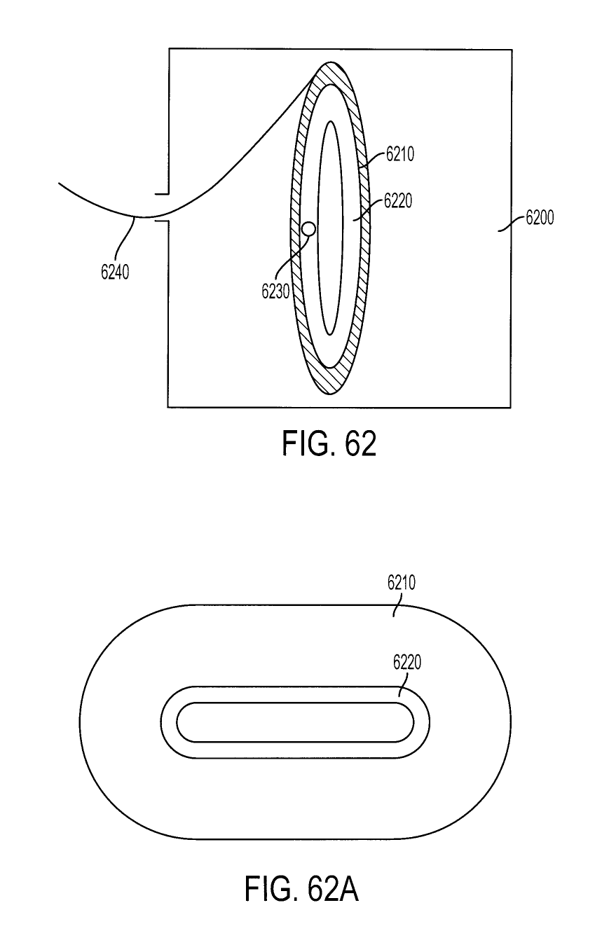

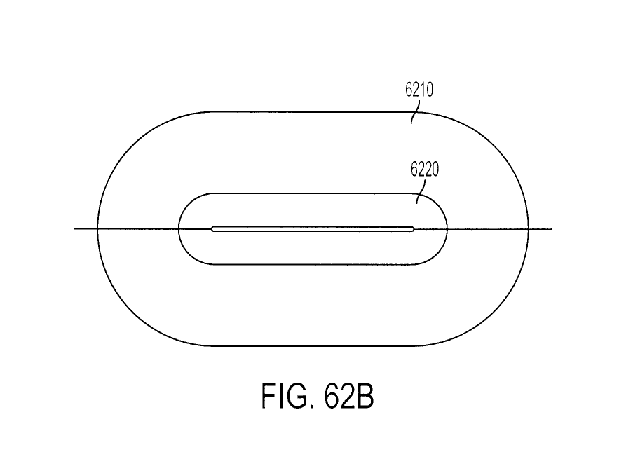

FIGS. 62, 62a, and 62b illustrate cam designs which are employed to dampen and regularize the feel of the sheet product as it is dispensed. In FIG. 62, sheet product refill 6210 is connected to sheet product package 6200 by way of a fixed hinge point 6230. Hinge point 6230 comprises a protrusion which extends into a corresponding slot 6220 in the refill or an end cap inserted therein. As sheet product 6240 is dispensed, sheet product refill 6210 follows a path which allows the refill to move in a geometry having a substantially constant radius, such as the oval paths illustrated in FIGS. 62, 62A, and 62B. To implement this concept, end caps inscribed with this path could be attached to both ends of the refill. Assuming a horizontal orientation, when the user is pulling the sheet product along the straight track they must pull hard enough to overcome the sliding friction between the track and the hinge point. This can be characterized by the equation: Min User Force=Weight of Refill×Friction Experienced in Path. When the user hits the end of the track and the sheet product is rotating, the user must pull hard enough to overcome the torque due to the rotating sliding friction between the hinge point and the path, which is helped by the oblong side of the sheet product falling. This can be characterized by the equation: Min User Force=[Weight of Refill×Hinge-Path Friction×Hinge Radius−Weight greater on one side of Hinge than Other Side×Mean Radius]/Radius of Sheet Product at Tangent Point. When the user rounds to the other side of that end of the track and the sheet product is rotating, the user must pull hard enough to overcome the torque due to the rotating sliding friction between the hinge and the path and lift the oblong weight of the foil. This can be characterized by the formula: Min User Force=[Weight of Sheet Product Assembly×Hinge-Path Friction×Hinge Radius+Weight greater on one side of Hinge than Other Side×Mean Radius]/Radius of Sheet Product at Tangent Point. If the user applies substantially uniform force throughout the dispensing process, the sheet product will exit at varying velocities at different points along the track.

Still another damping concept is to attach a central pivot to a non-round core. Then attach this pivot peg to a variable damping device that slows the roll when it is going too fast and makes the rotation require more force when the force naturally drops.

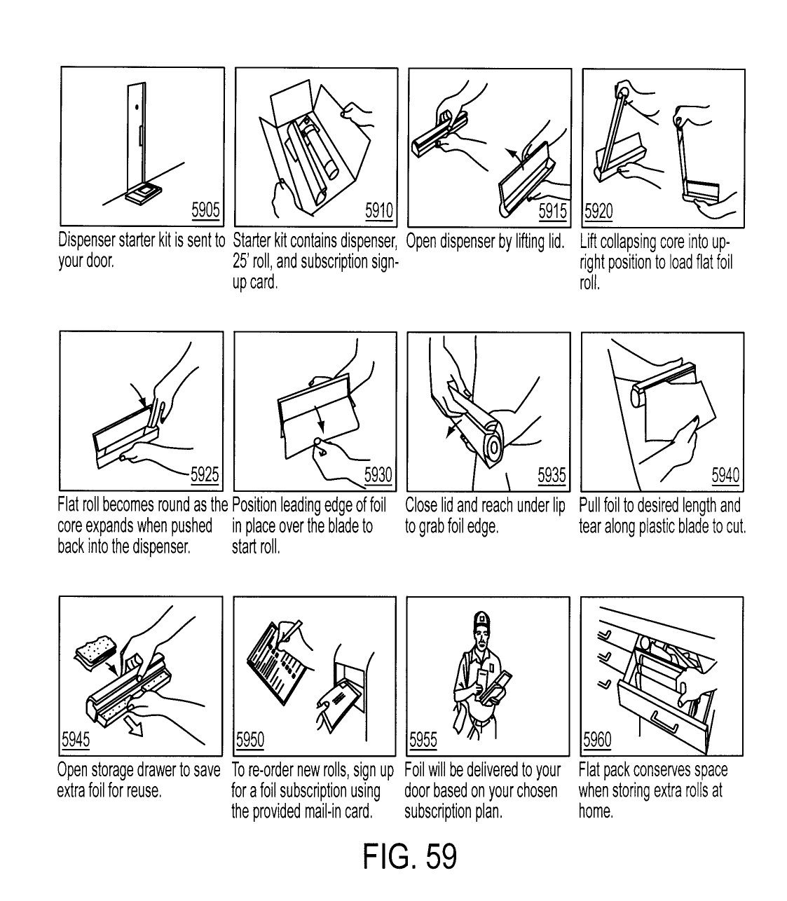

FIG. 59 illustrates an exemplary sheet product delivery business method. Although described herein as being used to distribute refills having a substantially flat geometry, it should be apparent to those skilled in the art that refills of alternative geometries can be distributed in a like manner without departing from the spirit or the scope of the distribution method. In block 5905, a sheet product package starter kit is delivered to the user. The starter kit can comprise a sheet product package, roll of sheet product, and a subscription sign-up card (block 5910). The user opens the sheet product package (block 5915), inserts the sheet product refill onto a mandrel or otherwise loads the refill (block 5920) and locks the refill into the sheet product package (block 5925). Any pre-positioning of the sheet product prior to dispensing is performed in block 5930, and then the lid of the sheet product package is closed (block 5935). The user then dispenses any desired sheet product (block 5940), and can store for later use any cut-offs in a drawer of the sheet product dispenser (block 5945). In block 5950, the user can sign up for a sheet product subscription. Such subscription allows selected sheet products to be regularly shipped to the user, without the user having to remember to request such shipments. Although the sign-up is illustrated using a paper-based card, alternative sigh-up methods, including on-line sign ups, are also contemplated and within the scope of the business method. In some embodiments, the user can elect different replenishment periods for different types of sheet products via a single sign-up process. In block 5955, the sheet products are delivered to the user at the chosen intervals. In block 5960, should the user have extra sheet product refills or should be sheet product refills arrive early, the sheet product refills can be stored in a drawer, pantry, or the like. Refills having a substantially flat orientation may be especially suitable for such a business method, as this shape facilitates easy shipping and storage.

While a detailed description has been provided with reference to specific embodiments, it will be apparent to those skilled in the art that various changes and modifications can be made therein without departing from the spirit and scope thereof. Thus, it is intended that the instant disclosure cover the modifications and variations of this invention provided they come within the scope of the appended claims and their equivalents. By way of example, without limitation, concepts described in conjunction with one sheet product package may be added to or substituted for components and/or concepts of other sheet product packages without departing from the spirit or the scope of the disclosure.

1. A sheet product package comprising:
a lid comprising four side surfaces and a top surface formed to enclose a first volume, wherein the first and third side surfaces are substantially parallel to each other, wherein the second and fourth side surfaces are substantially parallel with each other, and wherein the first side surface, the third side surface, and the top surface, when viewed collectively, comprise an hourglass indent;
a base, the base further comprising:
i) four side surfaces and a bottom surface formed to enclose a second volume, wherein the first and third side surfaces are substantially parallel to each other, wherein the second and fourth side surfaces are substantially parallel to each other, and wherein the first side surface, the third side surface, and the bottom surface, when viewed collectively, comprise an hourglass indent; and,
ii) a cutting edge disposed along the first side of the base proximate to the second volume; and,
a hinge, wherein the hinge is coupled to the third surface of the lid and the third surface of the base, wherein, when the hinge is in a closed position, the first volume is substantially centered above the second volume.

2. Claim 1, wherein the hourglass indent of the lid and the hourglass indent of the base are substantially similar.

3. Claim 2, wherein the hourglass indent of the lid is substantially centered along the first and third sides.

4. Claim 2, wherein the hourglass indent of the base is substantially centered along the first and third sides.

5. Claim 1, wherein at least one of the second side surface and the fourth side surface of the lid comprises a roll remainder indicator.

6. Claim 5, wherein the roll remainder indicator comprises a translucent or transparent panel.

7. Claim 1, wherein the lid further comprises at least one thumb ridge.

8. Claim 1, wherein the top surface further comprises at least one flat surface.

9. Claim 8, wherein the flat surface further comprises at least one detent.

10. Claim 1, wherein the bottom surface further comprises at least one flat surface.

11. Claim 10, wherein the flat surface further comprises at least one detent.

12. Claim 1, wherein the sheet product package further comprises a textured portion.

13. Claim 1, wherein the lid further comprises a cutting edge cover.

14. Claim 13, wherein the cutting edge cover further comprises at least one recess.

15. Claim 1, wherein the cutting edge further comprises a flange.

16. Claim 15, wherein the flange further comprises at least one reinforcing rib.

17. Claim 1, wherein the lid and the base further comprise at least one mating detent, wherein the mating detents positively engage to hold the sheet product package in a closed position.

18. Claim 1, wherein the lid and the base further comprise at least one rare earth magnet, wherein the rare earth magnets hold the sheet product package in a closed position.

19. A sheet product package comprising:
a lid, the lid further comprising:
i) four side surfaces and a top surface formed to enclose a first volume, wherein the first and third side surfaces are substantially parallel to each other, wherein the second and fourth side surfaces are substantially parallel with each other, and wherein the first side surface, the third side surface, and the top surface, when viewed collectively, comprise an hourglass indent;
ii) a roll remainder indicator, wherein the roll remainder indicator comprises a translucent or transparent panel;
iii) at least one flat surface;
iv) a cutting edge cover; and,
v) at least one mating detent; and,
a base, the base further comprising:
i) four side surfaces and a bottom surface formed to enclose a second volume, wherein the first and third side surfaces are substantially parallel to each other, wherein the second and fourth side surfaces are substantially parallel to each other, and wherein the first side surface, the third side surface, and the bottom surface, when viewed collectively, comprise an hourglass indent;
ii) at least one flat surface;
iii) a cutting edge disposed along the first side of the base proximate to the second volume, wherein the cutting edge further comprises a flange, the flange comprising at least one reinforcing rib; and,
iv) at least one mating detent, wherein the at least one mating detent of the lid and the at least one mating detent of the base positively engage to hold the sheet product package in a closed position; and,
a hinge, wherein the hinge is coupled to the third surface of the lid and the third surface of the base, wherein, when the hinge is in a closed position, the first volume is substantially centered above the second volume.

20. Claim 19, wherein the hourglass indent of the lid and the hourglass indent of the base are substantially similar.

21. Claim 20, wherein the hour glass indent of the lid is substantially centered along the first and third sides.

22. Claim 20, wherein the hourglass indent of the base is substantially centered along the first and third sides.

23. Claim 19, wherein the lid further comprises at least one thumb ridge.

24. Claim 19, wherein the flat surface of the lid and the flat surface of the base further comprise at least one detent.

25. (canceled)

26. Claim 19, wherein the cutting edge cover further comprises at least one recess.
